(19) United States
(12) Patent Application Publication
(10) Pub. No.: US 2003/0183616 A1
(43) Pub. Date: Oct. 2, 2003

(54) Ceramic heater

(75) Inventor: Yoshinobu Goto, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/395,825

(22) Filed: Mar. 24, 2003

(30) Foreign Application Priority Data
Mar. 28, 2002 (JP) P2002-90923
Jan. 16, 2003 (JP) P2003-7821

(51) Int. Cl. H05B 3/74

(52) U.S. Cl. 219/444.1; 219/468.1

(57) ABSTRACT

An object of the present invention is to provide a ceramic heater so that the uniformity of temperature on its heating face may be improved and cold spots on the heating face may be effectively prevented. The ceramic heater 1 has a ceramic substrate 2 having a heating face 2a, a heating resistance embedded in the substrate 2 and a terminal 6 electrically connected with the resistor. The resistor includes first windings 3A, 3B and second winding 4. The first winding 3A or 3B has a winding diameter larger than that of the second winding 4. A non-wound wire may be used instead of the second winding 4.

This application claims the benefits of Japanese Patent Applications P2002-90923 filed on Mar. 28, 2002, and P2003-7821 filed on Jan. 16, 2003, the entireties of which are incorporated by reference.

### BACKGROUND OF THE INVENTION

1. Field of the Invention

The invention relates to a ceramic heater, for example, suitable for a system for producing semiconductors.

2. Related Art Statement

In a system for producing semiconductors, a ceramic heater may be provided for heating a wafer so as to deposit a semiconductor thin film on the wafer from gaseous raw materials such as silane gas by means of thermal CVD or the like. In such ceramic heater, it is required to make the temperature of the heating face and the semiconductor wafer mounted thereon uniform at a high precision.

It has been known several techniques for reducing temperature distribution on the heating (mounting) face of the ceramic heater. For example, so-called two-zone heater is known as such heater. Such two-zone heater has a ceramic substrate and inner and outer resistance heat generators embedded in the substrate. Separate power supply terminals are connected to the respective heat generators so that electric power may be applied independently on the respective generators. Heat generated from the inner and outer heat generators may be thus independently controlled.

Such type of two-zone heater includes the followings. Japanese patent publication 2001-102157A discloses a heater having a ceramic substrate and two layers of heating elements embedded in the substrate. The calorific values in the inner zone and outer zone of each heating element are controlled so that two-zone control system of inner and outer zones may be realized.

### SUMMARY OF THE INVENTION

When a ceramic heater is used as a susceptor for mounting a semiconductor, various functional members may be embedded in a ceramic substrate of the heater other than a heating resistance. For example, an electrode for electrostatic chuck or for generating high frequency may be embedded in the substrate. Further, various kinds of holes may be formed in the substrate. Such holes include a hole for inserting a lift pin supporting a semiconductor wafer, a hole for supplying a back side gas, and a hole for inserting a thermocouple. When the above functional members or holes are provided in the ceramic substrate, the functional members and holes constitute structural defects in the ceramic substrate. When the heating resistance is further embedded in the substrate, it is thus necessary to provide a specific distance between the heating resistance and the functional member or hole. The planar pattern of the embedded heating resistance is limited by the necessity of providing the specific distance.

For example in a ceramic heater 31 shown in FIG. 10, a winding 3C having a shape of a coil spring is embedded in a ceramic substrate 2, and both ends of the winding 3C are connected with terminals 6, respectively. Such heating resistance having a shape of a coil spring has a relatively large substantial diameter (winding diameter of the coil spring). It is thus possible to reduce the temperature change (reduction) in the direction of thickness of the substrate 2. Such reduction of temperature change is advantageous for improving the uniformity of temperature on the heating face of the substrate 2. It is preferred to embed the heating resistance 3C uniformly as possible over the whole of the heating face of the heater. The heating resistance has been embedded according to planar pattern of concentric circles or spiral pattern for this reason.

When such heating resistance having a shape of coil spring is embedded for improving the uniformity of temperature on the heating face, however, it is impossible to provide the heating resistance on and near the functional members and holes provided in the substrate. Such limitation on the design of the planar pattern of the heating resistance may be a cause of cold spots on the heating face. The reasons are as follows. It is necessary to provide a safety distance of a some degree between the hole and heating resistance, considering the dimensional tolerances of processes of machining the hole and embedding the heating resistance in the substrate. Further, it is necessary to assure insulation between the functional member and heating resistance for preventing short-cut. The insulation is decided by a distance between the functional member and heating resistance, shapes of the functional member and heating resistance, and the volume resistivity of a ceramics. It is thereby necessary to provide a safety distance between the functional member and heating resistance in the substrate. When such safety distance is provided between the functional member and heating resistance, however, cold spots may be observed depending on the design.

For example in an example shown in FIG. 10, a pair of functional members 7 such as terminals for an electrode for electrostatic chuck are positioned at a small distance. Further in the present example, a pair of terminals 6 for a heater are positioned at a small distance. Such design is applied for joining a tube-shaped supporting member to the central part of the back face of a heater and inserting power supply means inside of the supporting member. In this case, it is required the above design of positioning the terminals 6, 7 in a central part of the substrate 2. When a pair of the connecting members 7 and a pair of the connecting members 6 are positioned in a relatively small central part at small distances, however, it becomes difficult to embed the heating resistance near a pair of the connecting members 7. The reason is that the distance of the connecting members 7 is too small to assure a sufficiently large space for inserting the heating resistance therebetween. The room for inserting the heating resistance is also small between the terminals 6 and 7. As a result, cold spots may be observed between the connecting members 7 and the surrounding region 28.

An object of the present invention is to provide a novel ceramic heater so that the uniformity of temperature on its heating face may be improved and cold spots on the heating face may be effectively prevented.

The present invention provides a ceramic heater having a ceramic substrate with a heating face, a heating resistance embedded in the substrate and a terminal electrically connected with the heating resistance. The heating resistance includes first and second windings, and the first winding has a winding diameter larger than that of the second winding.

The present invention further provides a ceramic heater having a ceramic substrate with a heating face, a heating resistance embedded in the substrate and a terminal electrically connected with the heating resistance. The heating resistance includes a winding and a non-wound wire.

The inventors have reached the idea that the combination of a first winding having a larger winding diameter and a second winding having a smaller winding diameter is applied as the heating resistance embedded in a heater substrate. Further, they have reached the idea that the combination of a winding and a non-wound wire as the heating resistance. Such structures are proved to be effective for improving the uniformity of temperature on the heating face of the heater and for preventing cold spots on the heating face. The present invention is based on the discovery.

These and other objects, features and advantages of the invention will be appreciated upon reading the following description of the invention when taken in conjunction with the attached drawings, with the understanding that some modifications, variations and changes of the same could be made by the skilled person in the art.

### BRIEF DESCRIPTION OF THE DRAWINGS

FIG. 1 is a view showing planar pattern of a heating resistance 16 embedded in a ceramic heater 1 according to one embodiment of the present invention.

FIG. 2 is an enlarged view showing an essential part of FIG. 1.

FIG. 3 is a diagram showing planar pattern of a heating resistance according another embodiment of the present invention.

FIG. 4 is a cross sectional view, cut along a IV-IV line in FIG. 1, showing a heating system 17 having the heater of FIG. 1 and a supporting member 13.

FIG. 5 is a cross sectional view, cut along a V-V line in FIG. 1, showing the heating system 17 having the heater of FIG. 1 and the supporting member 13.

FIG. 6 is a diagram showing planar pattern of a heating resistance 16 in a heater 21 according to another embodiment of the present invention.

FIG. 7 is an enlarged view showing an essential part of planar pattern of the heating resistance in FIG. 6.

FIG. 8 is a diagram showing pattern of a winding 3 and non-wound wire 9 (pattern cut along a line in the direction of thickness of the substrate 2, in still another embodiment of the present invention.

FIG. 9 is a plan view showing pattern of windings embedded in a heater according to another embodiment of the invention, in which the windings have three winding diameters LA, LD and LE, respectively.

FIG. 10 is a diagram showing planar pattern of a heating resistance embedded in a ceramic heater 31 according to a reference example.

FIG. 11 is an enlarged view showing an essential part of FIG. 10.

### PREFERRED EMBODIMENTS OF THE INVENTION

The present invention will be described further in detail, referring to the attached drawings.

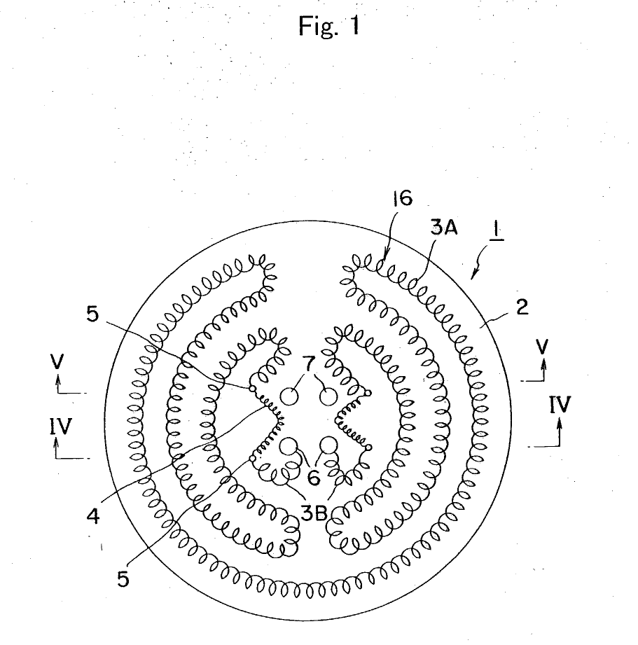

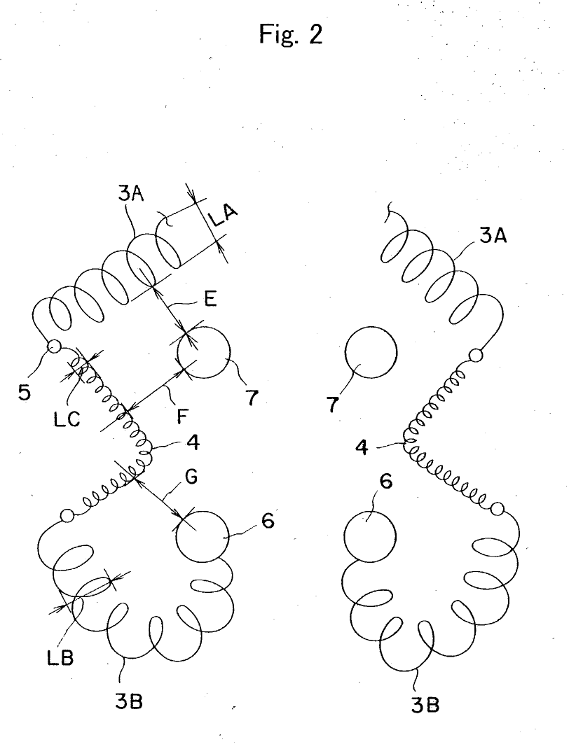

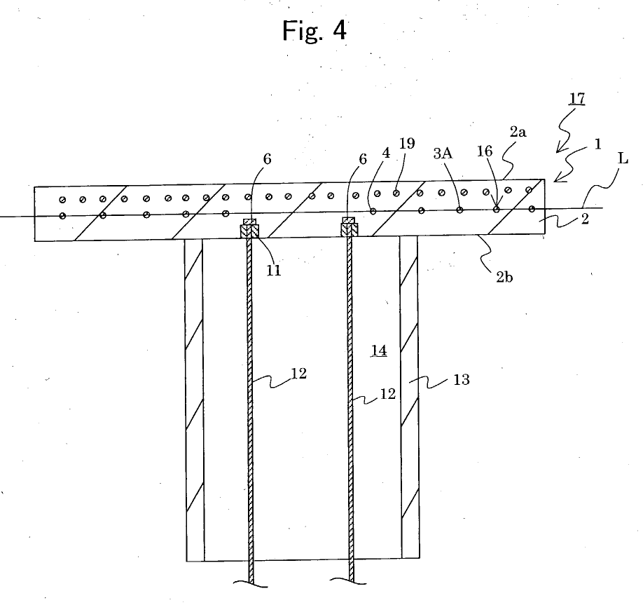

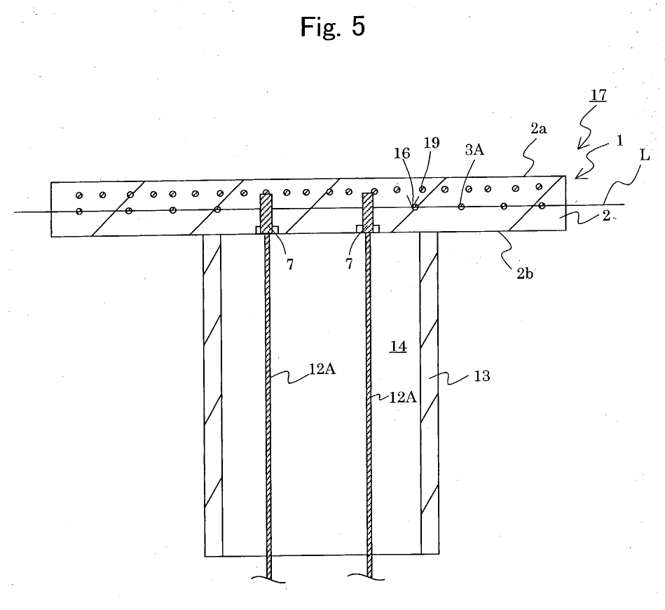

FIG. 1 is a diagram showing pattern of a heating resistance 16 embedded in a ceramic substrate 2, in a ceramic heater according to one embodiment of the present invention. FIG. 2 is an enlarged view of FIG. 1. FIGS. 4 and 5 show a heating system 17 having the ceramic heater 1 and a supporting member 13. In the heater 1, the heating resistance is embedded in the substrate 2 and not exposed to the surface of the substrate. In FIG. 1, however, cross sectional hatching is omitted for clearly showing planar pattern of the heating resistance.

The whole of the heating system will be described first, referring to FIGS. 4 and 5. The substrate 2 substantially has a shape of a disk. Windings 3A, 4 and 3B, as well as another functional member 19, are embedded inside of the substrate 2. As shown in FIG. 4, the heating resistance 3B is connected with a power supply means 12 through terminals 6 and 11. Further, as shown in FIG. 5, the functional member 19 is connected with a power supply means 12A through the terminal 7. The functional member 19 is, for example, an electrode for an electrostatic chuck.

A hollow supporting member 13 has an end face joined with a back face 2b of the substrate 2. The joining method is not particularly limited. The joining may be carried out by soldering, fixing with bolts, or solid phase welding as described in Japanese patent publication P8-73280A. The heater and supporting member may be joined and sealed using a sealing member such as an O-ring and a metal packing. The supporting member 13 has a cylindrical shape. The supporting member 13 defines an inner space 14 separated from atmosphere in a chamber. The power supply means 12 and 12A are contained in the inner space 14.

In the present embodiment, the first wirings 3A, 3B and second winding 4 are embedded in the substrate 2 as heat generators. The first wiring 3A is embedded according to planar pattern substantially of a shape of a spiral. Both ends of the first winding 3A are connected with the second winding 4 through the terminals, respectively. The other end of each winding 4 is connected with the first winding 3B. Each end of each winding 3B is connected with the terminal 6.

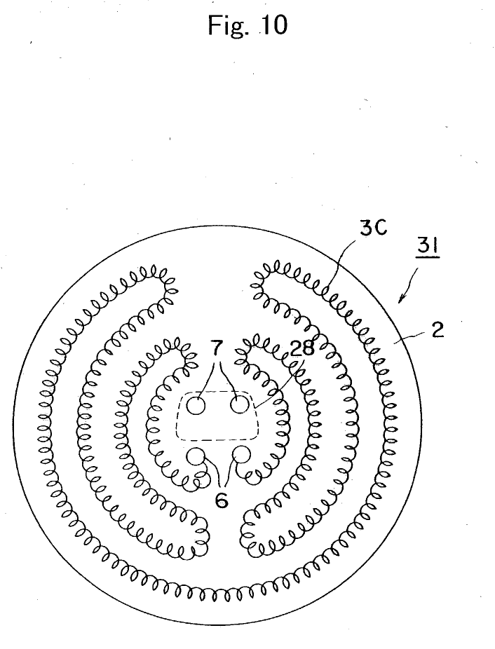

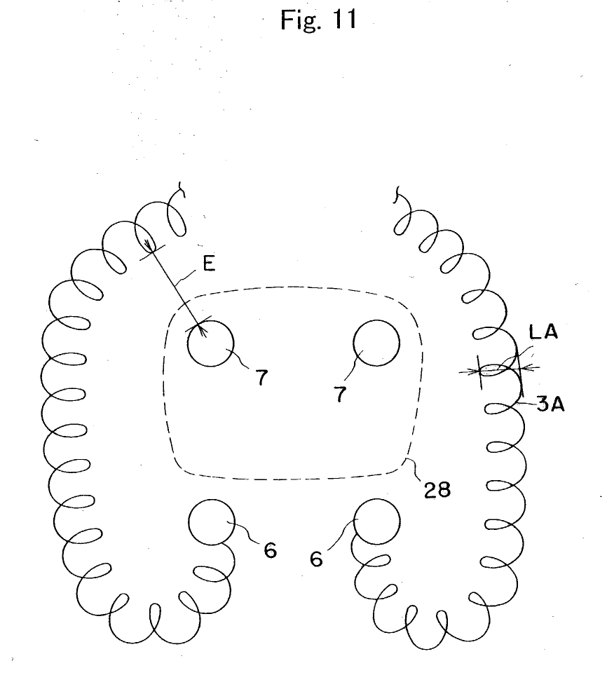

As shown in FIG. 2, according to the present invention, the winding diameters LA, LB of the first windings 3A, 3B are made larger than the winding diameter LC of the second winding 4. The advantages will be described below. In the heating resistance having the planar pattern shown in FIG. 10, the winding diameter LA of the heating resistance 3A is constant as shown in an enlarged view of FIG. 11. It is necessary to assure insulation and tolerance on the viewpoint of the precision of production, between the heating resistance 3A and terminal 7. It is thus demanded to provide a safety distance “E” between the resistor 3A and terminal 7. As a result, it is necessary to design the planar pattern of the heating resistance 3A so that it is substantially distant from a pair of the terminals 7. Such design inevitably results in cold spots 28 on the heating face.

On the contrary, according to the present invention, the winding 4 having a smaller winding diameter is provided near a structural defect, for example the terminal 7, as shown in FIG. 2. Since the winding diameter LC of the winding 4 is small, the winding 4 may be easily bent and embedded in planar pattern such that the distances between the winding 4 and the terminals 6 and 7 are minimized, while assuring safety distances F and G at the same time. When the winding 4 has a larger winding diameter, it is difficult to bent the winding 4 so that the distances between the winding 4 and the terminals 6 and 7 are minimized. It is thus possible to cancel, or at least reduce or prevent, the cold spots 28.

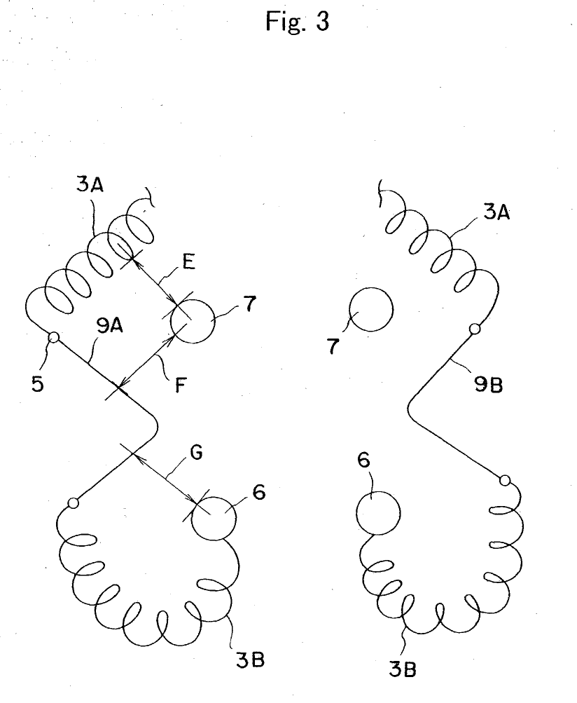

Further, in an embodiment of FIG. 3, non-wound wires 9A and 9B are used each composed of a wire of a conductive material, instead of the second winding. Also in this case, the distances F and G between the non-wound wires 9A, 9B and the terminals 6, 7 are minimized, assuring safety distances “F”, “G” at the same time.

As the winding diameters LA and LB of the first winding is larger, the temperature change (temperature reduction) in the direction of thickness of the substrate 2 may be further reduced. It is thus possible to facilitate the control for reducing the temperature distribution on the heating face 2a. The winding diameters LA, LB of the first winding may preferably be not smaller than 1.0 mm and more preferably be not smaller than 1.5 mm on the viewpoint. When the winding diameter of the first winding is larger, however, a thicker ceramic substrate is needed for embedding the winding, so that the thermal capacity of the heater is increased. The winding diameter of the first winding may preferably be not larger than 20 mm for reducing the thermal capacity of the ceramic heater.

The winding diameter LC of the second winding may preferably be not larger than 10 mm and more preferably be not larger than 5 mm on the viewpoint of the present invention. Further, LC (winding diameter of the second winding)/LA, LB (winding diameter of the first winding) may preferably be not larger than 0.9 and more preferably be not larger than 0.8 on the viewpoint of the present invention. Further, a difference between LC (winding diameter of the second winding) and LA, LB (winding diameter of the first winding) may preferably be not smaller than 1 mm and more preferably be not smaller than 2 mm on the viewpoint of the present invention.

The lower limit of the winding diameter LC of the second winding is not particularly defined and preferably be not smaller than 0.5 mm for facilitating the mass production.

In a preferred embodiment, as shown in FIGS. 1 to 3, the substrate has a structural defect 7. Such structural defect means a part in the substrate in which an object different from the ceramics constituting the substrate, a space or hollow is provided. Such object includes a ceramics different from the ceramics constituting the substrate, a metal (including an alloy) and a composite material of a metal and ceramics. More specifically, such object includes a terminal, conductive connection part, an electrode for generating high frequency, an electrode for electrostatic chuck and a thermocouple. The space or hollow includes a hole for inserting a lift pin, and a hole for supplying back side gas.

The distances F and G between the second winding or non-wound wire and structural defect may preferably be not larger than 40 mm, and more preferably be not larger than 30 mm, for reducing cold spots. When the distance between the second winding or non-wound wire and structural defect is too small, the insulating property is reduced or the tolerance of design might not be assured. The safety distance sufficient for securing the insulation is decided by the conductivity of the ceramics constituting the substrate and the temperature for use of the heater. Each of the distances F and G between the second winding or non-wound wire and structural defect may preferably be not smaller than 1 mm, and more preferably be not smaller than 2 mm, on the viewpoint.

The first winding and second winding or non-wound wire may be directly connected or preferably be connected through a terminal. In this embodiment, the winding and terminal, or non-wound wire and terminal, may be joined by means of a method not particularly limited including winding to a screw portion, caulking, fitting, soldering, welding or eutectic welding.

The substrate for the heater may be made of a ceramic material not particularly limited. The material for the substrate may be a known ceramic material including a nitride ceramics such as aluminum nitride, silicon nitride, boron nitride and sialon, and an alumina-silicon carbide composite material. Aluminum nitride or alumina is most preferred for providing excellent anti-corrosion property against a corrosive gas such as a halogen based corrosive gas.

The shape of the substrate is not particularly limited and may preferably be disk shaped. Pocket shaped parts, emboss-shaped parts, or grooves may be formed on the heating face.

The substrate may be produced by means of a method not particularly limited, preferably by hot pressing and hot isostatic pressing.

A material for the heating resistance may preferably be tantalum, tungsten, molybdenum, platinum, rhenium, hafnium or the alloys of these metals. In particular, when the ceramic substrate is made of aluminum nitride, the material of the heating resistance may preferably be pure molybdenum or an alloy containing molybdenum. The material of the heating resistance may be a conductive material such as carbon, TiN or TiC, in addition to the high melting point metals described above.

The wire diameters of the first and second windings may be decided depending on required supply of calorific value, winding diameter, thermal conductivity and shape of the substrate. Generally, the wire diameter may preferably be 0.05 to 3 mm. The wire diameter of the non-wound wire may preferably be not smaller than 0.1 mm for facilitating the connection of the wire to the terminal. Further, the diameter of the non-wound wire may preferably be not larger than 2 mm for supplying energy of a reasonable calorific value through the non-wound wire and to reduce cold spots.

The material of the terminal electrically connected with the heating resistance may preferably be the material for the heating resistance described above.

The application of the heater according to the present invention is not limited, and may preferably for a system for producing semiconductors. Such system means a system usable in a wide variety of semiconductor processing in which metal contamination of a semiconductor is to be avoided. Such system includes a film forming, etching, cleaning and testing systems.

The shape of each power supply means is not particularly limited, and may be a rod shaped body, a wire shaped body or a combination of rod and wire shaped bodies. A material for each power supply means is not particularly limited. The power supply means is separated from atmosphere in a chamber and thus do not directly exposed to a highly corrosive substance. The material of the supply means may thus preferably be a metal and most preferably be nickel.

Each heating resistance does not necessarily have a planar pattern composed of one continuous line without branching or coupling between the corresponding terminals. Each heating resistance may have an electrical branching part or coupling part between the terminals.

In a preferred embodiment, the first and second windings (or non-wound wire) are embedded along a plane “L” substantially parallel with the heating face 2a (see FIGS. 4 and 5). The advantages of the present invention is most considerable in this case. In this embodiment, it is required that the plane “L” passes through at least a part of each beating resistance. It is not required that the geometrical center of each heating resistance is on the plane “L” in a geometrically strict meaning. In addition to this, it is allowed that the central plane of each heating resistance is dislocated from the plane “L” due to any reasons including manufacturing error, allowance or tolerance.

In a preferred embodiment, each heating resistor is provided so that the heating resistance is substantially parallel with the heating face 2a. It is thus possible to further improve the uniformity of temperature on the heating face 2a. In this embodiment, the resistor may be parallel with the heating face in a geometrically strict meaning. Alternatively, the heating resistance may be intersected at the heating face 2a at a sufficiently small angle such as −0.5 to +0.5 degree. Furthermore, a tolerance in the manufacturing process may be allowed.

In a preferred embodiment, at least a pair of structural defects are provided in the substrate and the second winding or non-wound wire passes through the structural defects. That is, when at least a pair of the structural defects are provided in the substrate, it is difficult to provide a sufficiently large space between the structural defects. Cold spots may be often observed on the heating face between the structural defects. For example in an example shown in FIG. 10, cold spots may be often observed between a pair of the structural defects 7 or between the structural defects 6 and 7.

When a distance between the structural defects is small, however, it is difficult to provide a winding having a normal size between the structural defects due to the limitation on the design described above. According to the present invention, the non-wound wire or second winding having a smaller winding diameter is inserted between the structural defects. In addition to this, the first winding having a larger winding diameter may be used in the other region at the same time. It is thus possible to prevent cold spots mainly observed in the region between the structural defects.

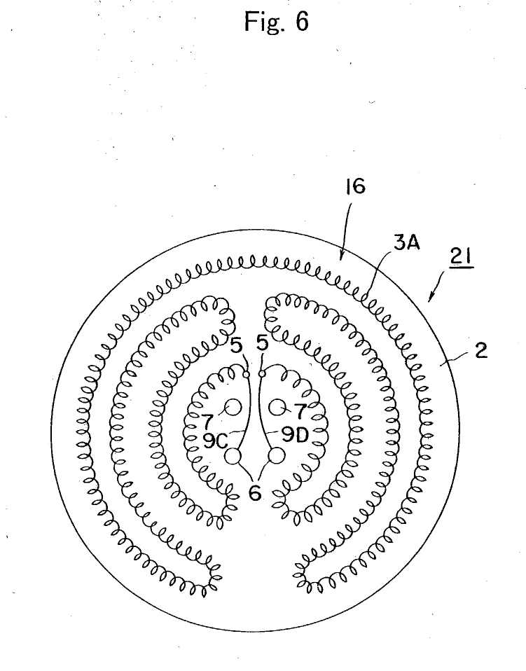

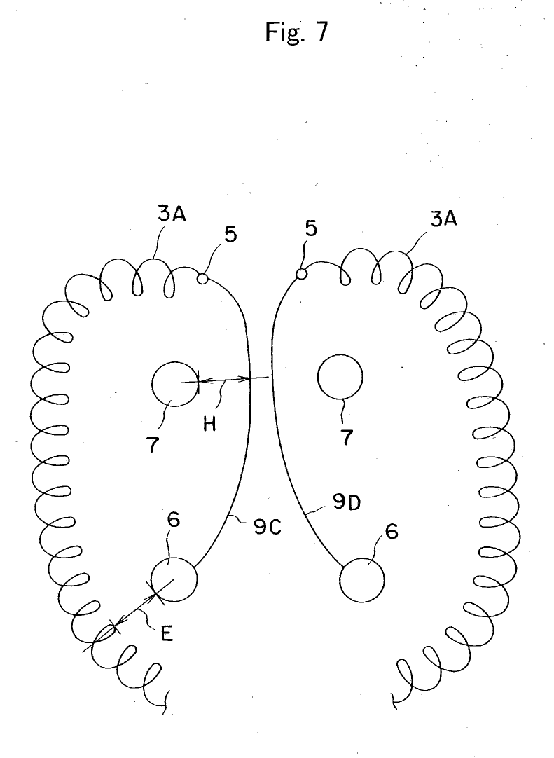

FIG. 6 is a diagram showing planar pattern of embedded heating resistance 16 and terminals 6, 7, and FIG. 7 is an enlarged view of them.

In the present example, a winding 3A and non-wound wires 9C and 9D are embedded in the substrate 2 of a ceramic heater 21. The winding 3A and non-wound wires 9C , 9D are connected through a terminal 5. Each end of each of the non-wound wires 9C, 9D is connected with each terminal 6. As shown in FIG. 7, each of the non-wound wires 9C, 9D passes through a pair of the terminals 7 and then connected with the corresponding terminals 6. It is required that the distance “H” between each of the non-wound wires 9C, 9D and each terminal 7 be not smaller than the safety distance described above. The non-wound wire may be replaced by the second winding having a smaller winding diameter.

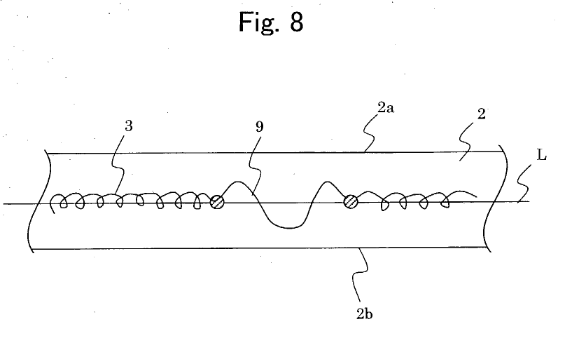

In a preferred embodiment, the non-wound wire or second winding may be bent or curved in the direction of thickness of the substrate. For example, in an example shown in FIG. 8, the first winding 3 is formed along the plane “L” substantially parallel with the heating face 2a of the substrate 2. The non-wound wire 9 is bent toward the heating face 2a and back face 2b from the plane “L” in the direction of the thickness. The advantages are as follows. When the non-wound wire is elongated along the plane “L”, the distance between the non-wound wire 9 and heating face 2a and the distance between the wire 9 and back face 2b are relatively large. Temperature gradient may be often induced between the wire 9 and heating face 2a and wire 9 and back face 2b so that temperature distribution on the heating face may be increased. The non-wound wire 9 is bent in the direction of thickness of the substrate 2 so as to reduce the temperature distribution in the direction of thickness thereof.

The non-wound wire 9 used in the above example described referring to FIG. 8 may be replaced with the second winding having a smaller winding diameter.

Two kinds of windings are embedded in the substrate in the above examples. In the present invention, three or more kinds of windings having three or more kinds of winding diameters may be embedded in a single substrate. It is thus possible to control the temperature distribution on the heating face more accurately depending on the actual design of the heater, so that the tolerance of the design may be further improved.

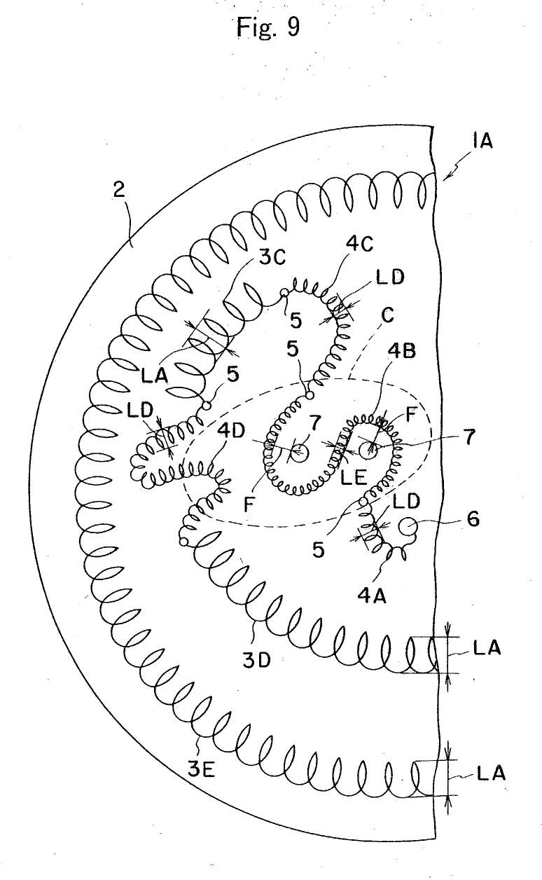

FIG. 9 is a view showing planar pattern of embedded windings in a heater according to this embodiment. In this figure, the left half of the planar pattern of the windings is shown. The planar pattern is substantially identical in the remaining right half. In a heater 1A of the present example, the terminal 6 and a pair of the structural defects 7 are provided in the substrate 2. Cold spots may be easily induced in the region of the defects 7 and their surrounding region C.

In the present example, the outermost winding 3E and the inner windings 3D and 3C have a larger winding diameter LA. These windings are smoothly curved and substantially arc-shaped so that they are easily deformed and bent even when the winding diameter LA is relatively large. It is rather advantageous to increase the winding diameter to supply calorific power over a wider area for improving the uniformity of temperature on the heating face.

On the other hand, windings 4B are formed so that the windings 4B pass through a pair of the structural defects 7 and surrounding the defects 7, respectively. As described above, it is necessary to minimize the winding diameter LE of the winding 4B for assuring a safety distance “F” near the defect 7.

Further, in the present example, a winding 4A having a winding diameter LD is provided between the winding 4B having the smallest winding diameter LE and the terminal 6. A winding 4C having a winding diameter LD is provided between the windings 4B and 3C. The regions where the windings 4A, 4C are provided are distant from the structural defects 7. It is thus desirable to increase the winding diameter LD for supplying calorific power in a wider area. In the regions, however, the curvature is relatively large. It becomes thus difficult to smoothly bent the windings 4A and 4C when the winding diameter LA is increased so that the possibility of breaking of wire and current concentration may be increased. The winding diameter LD of the windings 4A and 4C is adjusted at a value between the winding diameters LE and LA.

In the planar pattern of the present example, cold spots may be easily induced on the heating face in the region of the structural defect 7 and the surrounding region as described above. In the present example, the winding 4D is bent and curved in the region surrounding the defect 7 so that the calorific value is increased to reduce the cold spots. When the winding 4D is bent, however, the curvature is increased. The winding diameter LD of the winding 4D is reduced compared with the winding diameter LA for facilitating the deformation of the winding 4D.

Further in the present embodiment, windings having four kinds of winding diameters may be provided. It is also possible to replace the winding 4B surrounding the defect 7 with a non-wound wire.

### EXAMPLES

The heating system 17 shown in FIGS. 1, 2, 4 and 5 was produced. The substrate 2 was made of an aluminum nitride sintered body having a diameter ø of 350 mm and a thickness of 20 mm. The windings 3A, 3B and 4 were embedded in the substrate 2. The windings 3A and 3B had winding diameters LA and LB of 8 mm and the winding 4 had a winding diameter LC of 2 mm. The windings 3A and 3B had wire diameters of 0.4 mm and the winding 4 had a wire diameter of 0.1 mm. The terminal 5 was composed of a metal member for caulking. The distance “E” between the terminals 6, 7 and first winding was 3 mm. The distances “G” and “F” between the second winding 4 and terminals 6, 7 were 3.5 mm. The windings 3A, 3B and 4 were made of molybdenum metal. The terminals 6 and 7 were composed of cylindrical terminals made of molybdenum metal.

The supporting member 13 was composed of an aluminum nitride sintered body. The supporting member 13 had an outer diameter of 80 mm, an inner diameter of 50 mm, and a length of 250 mm. The supporting member 13 was joined with the back face 2b of the central part of the substrate 2 by means of solid phase welding. The electrical supply means 12 and 12A composed of nickel rods were inserted into the inner space 14 of the supporting member 13 and electrically connected with each of the terminals.

The temperature of the ceramic heater was elevated so that the average temperature on the heating face 2a was about 700° C. The temperature distribution on the heating face 2a was observed by a thermoviewer. As a result, the cold spot 28 shown in FIG. 10 were disappeared. A difference between the maximum and minimum temperatures on the heating face was proved to be 2° C.

As described above, the present invention provides a structure effective for improving the uniformity of temperature on the heating face of a heater and preventing cold spots on the heating face.

The present invention has been explained referring to the preferred embodiments. However, the present invention is not limited to the illustrated embodiments which are given by way of examples only, and may be carried out in various modes without departing from the scope of the invention.

1. A ceramic heater comprising a ceramic substrate having a heating face, a heating resistance embedded in said substrate and a terminal electrically connected with said heating resistance, wherein said heating resistance includes first and second windings and said first winding has a winding diameter larger than that of said second winding.

2. The heater of claim 1, wherein said substrate has a structural defect and a distance between said structural defect and said second winding is not larger than 40 mm.

3. The heater of claim 2, wherein said distance between said structural defect and said second winding is not smaller than 2 mm.

4. The heater of claim 1, wherein said first and second windings are provided along a plane substantially parallel with said heating face.

5. The heater of claim 1 functioning as a susceptor for mounting a semiconductor.

6. The heater of claim 2, wherein said substrate has at least a pair of said structural defects, and said second winding passes through a space between said structural defects.

7. A ceramic heater comprising a ceramic substrate having a heating face, a heating resistance embedded in said substrate and a terminal electrically connected with said heating resistance, wherein said heating resistance includes a winding and a non-wound wire.

8. The heater of claim 7, wherein said substrate has a structural defect and a distance between said structural defect and said non-wound wire is not larger than 40 mm.

9. The heater of claim 8, wherein said distance between said structural defect and said non-wound wire is not smaller than 2 mm.

10. The heater of claim 7, wherein said winding and said non-wound wire are provided along a plane substantially parallel with said heating face.

11. The heater of claim 7 functioning as a susceptor for mounting a semiconductor.

12. The heater of claim 8, wherein said substrate has at least a pair of said structural defects, and said non-wound wire passes through a space between said structural defects.
